(19) United States
(12) Patent Application Publication
(10) Pub. No.: US 2026/0299955 A1
(43) Pub. Date: Oct. 1, 2026

(54) COMBINED LOAD VALUE AND LOAD ADDRESS PREDICTION

(71) Applicants: Sudhanshu SHUKLA, Bengaluru (IN); Jayesh GAUR, Benglaru (IN); Raphael ZAILER, Hertzeliya (IL); Chen DAN, Hadera (IN); Sreenivas SUBRAMONEY, Bangalore (IN)

(72) Inventors: Sudhanshu SHUKLA, Bengaluru (IN); Jayesh GAUR, Benglaru (IN); Raphael ZAILER, Hertzeliya (IL); Chen DAN, Hadera (IN); Sreenivas SUBRAMONEY, Bangalore (IN)

(21) Appl. No.: 19/094,648

(22) Filed: Mar. 28, 2025

(51) Int. Cl. G06F 9/38; G06F 9/30; G06F 12/0811

(52) U.S. Cl. CPC G06F 9/3806; G06F 9/30043; G06F 9/30145; G06F 12/0811

(57) ABSTRACT

A processor of an aspect includes a decode unit to decode a load instruction. The load instruction is to indicate a destination register. The processor also includes a prediction unit to provide either a predicted address or a predicted value for the load instruction. The processor also includes a memory execution unit coupled with the prediction unit. The memory execution unit is to load a value corresponding to the predicted address and store the loaded value in the destination register or store the predicted value in the destination register. Other processors, methods, and systems are also disclosed.

### BACKGROUND

### Technical Field

Embodiments described herein generally relate to processors. In particular, embodiments described herein generally relate to loading data in processors.

### Background Information

Processors may be used to process data that has been loaded from system memory into the processor. The processors typically have an instruction set that includes one or more types of instructions to load the data from the system memory into registers of the processor. A few examples of such instructions include load instructions, move instructions, load multiple instructions, gather instructions, and the like. By way of example, a load instruction may indicate address generation information and a destination register and the load instruction when executed may cause the processor to load data from an address in system memory generated from the address generation information and to store the data in the destination register.

One challenge is that loading the data from the system memory tends to take a significant amount of time. In order to help improve performance the processors typically have one or more caches. The caches may represent relatively small amounts of data storage that are relatively close to the processor and from which the data can be accessed more rapidly than the data can be accessed from the system memory. By way of example, the processor may have a cache hierarchy including a Level 1 (L1) cache, a Level 2 (L2) cache, in some cases a Level 3 (L3) cache, where the L1 cache is closer to the execution logic of the processor than the L2 cache, and the L2 cache is closer to the execution logic of the processor than the L3 cache. Data can generally be accessed faster from the L1 cache than from the L2 cache, faster from the L2 cache than from the L3 cache, and faster from the L3 cache than from the system memory. During operation, some of the data in the system memory may be loaded into the caches. Subsequently, when the processor wants to perform a load instruction to load data, the load instruction may cause the processor to check the caches to see if the data has already been stored in the caches. If the data has already been stored in the caches (which is often referred to as a cache hit), then the processor may access the data relatively rapidly from the caches. Alternatively, if the data has not already been stored in the caches (which is often referred to as a cache miss), then the processor may need to access the data more slowly from the system memory.

Whether or not data can be loaded rapidly may have a direct impact on the performance. For example, so-called dependent instructions that occur after the load instructions in program order, and that are used to process the data loaded by the load instructions, may not be able to be executed until after the data has been loaded into the registers of the processor. When the data can be accessed rapidly from the caches, then these instructions may be executed relatively rapidly, which may help to provide good performance. However, when the data needs to be loaded more slowly from the system memory, these instructions may need to wait a significant amount of time (e.g., potentially hundreds of clock cycles or more) before they can be executed, which may tend to limit performance. Thus, it would be useful to be able to load data from system memory into processors more rapidly.

### BRIEF DESCRIPTION OF THE DRAWINGS

Various examples in accordance with the present disclosure will be described with reference to the drawings, in which:

FIG. 1 is a block diagram of an embodiment of a processor having a combined address and value prediction unit to predict either an address or a value for a load instruction.

FIG. 2 is a block flow diagram of an embodiment of a method predicting either an address or a value for a load instruction.

FIG. 3 is a block diagram of a more detailed example embodiment of a processor having a combined address and value prediction unit to predict either an address or a value for a load instruction.

FIG. 4 is a block diagram of a detailed example embodiment of a combined address and value prediction unit to predict either an address or a value for a load instruction.

FIG. 5 is a block diagram of an embodiment of a combined address and value prediction unit to determine whether to predict either an address or a value for a load instruction based in part on a characteristic of an access for a value with a predicted address.

FIG. 6 illustrates an example computing system.

FIG. 7 illustrates a block diagram of an example processor and/or System on a Chip (SoC) that may have one or more cores and an integrated memory controller.

FIG. 8(A) is a block diagram illustrating both an example in-order pipeline and an example register renaming, out-of-order issue/execution pipeline according to examples.

FIG. 8(B) is a block diagram illustrating both an example in-order architecture core and an example register renaming, out-of-order issue/execution architecture core to be included in a processor according to examples.

FIG. 9 illustrates examples of execution unit(s) circuitry.

FIG. 10 is a block diagram of a register architecture according to some examples.

FIG. 11 illustrates examples of an instruction format.

FIG. 12 illustrates examples of an addressing information field.

FIG. 13 illustrates examples of a first prefix.

FIGS. 14(A)-(D) illustrate examples of how the R, X, and B fields of the first prefix in FIG. 13 are used.

FIGS. 15(A)-(B) illustrate examples of a second prefix.

FIG. 16 illustrates examples of a third prefix.

FIG. 17 is a block diagram illustrating the use of a software instruction converter to convert binary instructions in a source instruction set architecture to binary instructions in a target instruction set architecture according to examples.

### DETAILED DESCRIPTION OF EMBODIMENTS

The present disclosure relates to apparatus, methods, and systems for combined load value and load address prediction. In the following description, numerous specific details are set forth (e.g., specific predictor designs, microarchitectural details, sequences of operations, etc.). However, embodiments may be practiced without these specific details. In other instances, well-known circuits, structures, and techniques have not been shown in detail to avoid obscuring the understanding of the description.

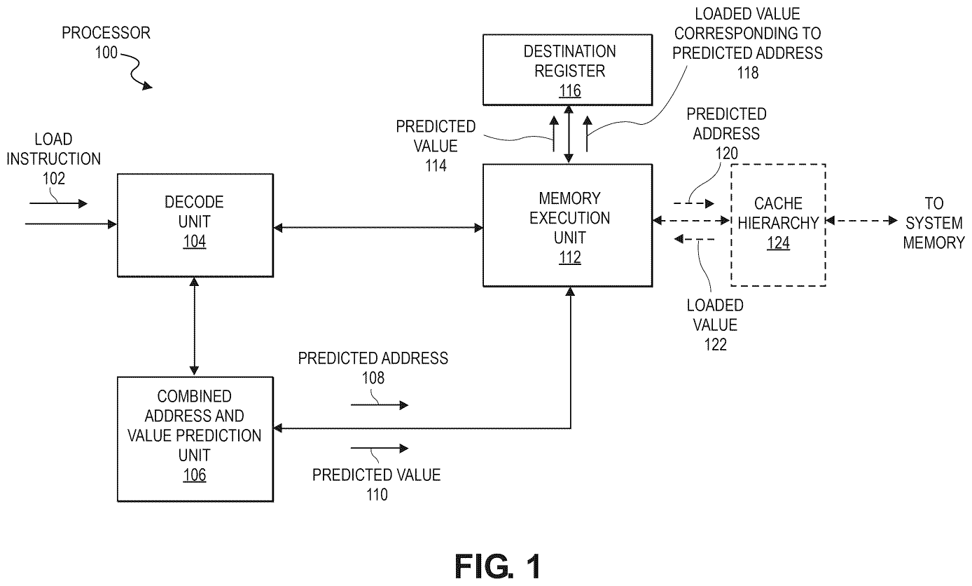

FIG. 1 is a block diagram of an embodiment of a processor 100 having a combined address and value prediction unit 106 to predict either an address 108 or a value 110 for a load instruction 102. In some embodiments, the processor may be a general-purpose processor (e.g., a general-purpose microprocessor or central processing unit (CPU) of the type used in desktops, laptops, servers, and other computer systems). Alternatively, the processor may be a special-purpose processor. Examples of suitable special-purpose processors include, but are not limited to, co-processors, graphics processors, network processors, communications processors, machine-learning processors, artificial intelligence processors, cryptographic processors, and digital signal processors (DSPs). In some embodiments, the processor may include at least some hardware (e.g., transistors, circuitry, etc.). In some embodiments, the processor may be included within at least one die, integrated circuit, or semiconductor substrate.

The processor includes a decode unit (e.g., decode circuitry). During operation, the decode unit may receive the load instruction 102. The load instruction may represent a macroinstruction, machine language instruction, or instruction of an instruction set of the processor. Examples of suitable load instructions include, but are not limited to, various types of scalar move or load instructions, vector move or load instructions, scalar load-multiple instructions, vector load-multiple instructions, gather instructions, and other types of scalar or vector instructions that move or load one or more values from system memory into one or more registers of the processor. The load instruction may explicitly specify (e.g., through one or more fields or a set of bits), or otherwise indicate (e.g., implicitly indicate), address generation information and a destination register 116 where data loaded from system memory is to be stored. As one example, the load instruction may have a first field or set of bits to explicitly specify a source register that is to store the address generation information and a second field or set of bits to explicitly specify the destination register. The address generation information may represent any of various types of information that may be used to generate an address of a location in system memory where the data or a value to be loaded is stored.

The decode unit may decode the load instruction into one or more lower-level control signals, operations, or decoded instructions (e.g., one or more micro-instructions, micro-operations, micro-code entry points, etc.). In some embodiments, the decode unit may include at least one input structure (e.g., a port, interconnect, or interface) coupled to receive the load instruction, an instruction recognition and decode logic coupled therewith to recognize and decode the load instruction into the one or more lower-level control signals, operations, or decoded instructions, and at least one output structure (e.g., a port, interconnect, or interface) coupled therewith to output the one or more lower-level control signals, operations, or decoded instructions. The decode unit and/or its instruction recognition and decode logic may be implemented using various instruction decode mechanisms including, but not limited to, microcode read only memories (ROMs), look-up tables, hardware implementations, programmable logic arrays (PLAs), other mechanisms suitable to implement instruction decoder circuitry, and combinations thereof. In some embodiments, the decode unit may include at least some hardware (e.g., transistors, circuitry, on-die read-only memory or other non-volatile memory storing microcode or other hardware-level instructions, or any combination thereof). In some embodiments, the decoder circuitry may be included within a die, integrated circuit, or semiconductor substrate.

The processor also includes the combined address and value prediction unit 106. The combined address and value prediction unit is a combined, hybrid, or unified predictor that is able to both predict the address 108 that would be generated for the load instruction and predict the value 110 that would be loaded by the load instruction. The combined address and value prediction unit may be able to use both load address prediction to predict the address and load value prediction to predict the value. Load address prediction may represent a technique that the processor may use to attempt to predict the address that would be generated for the load instruction (e.g., based on the address generation information provided by the load instruction) during the execution of the load instruction. Load value prediction may represent a technique that the processor may use to attempt to predict the data or value that would be loaded from system memory by execution of the load instruction.

The combined address and value prediction unit may be able to perform the load address and value predictions based at least in part on prior execution or history and predicting that what has happened before for the load instruction may be likely to happen again. For example, the prediction unit may detect that the same address has been generated for prior instances of the load instruction (e.g., in different iterations of loops, in different executions of the same code, etc.), and may predict that the same address will be generated again for a future instance of the load instruction. Similarly, the prediction unit may detect that the same value has been loaded for prior instances of the load instruction (e.g., in different iterations of loops, in different executions of the same code, etc.), and may predict that the same value will be loaded again for a future instance of the load instruction.

Referring again to FIG. 1, the processor also includes a memory execution unit 112 coupled with the combined address and value prediction unit 106. The combined address and value prediction unit may be coupled with the memory execution unit via a new early speculative load dispatch path or short circuit path added to execute the load instruction right after prediction occurs (e.g., which may occur right after allocation in some embodiments, as will be discussed further below), without waiting address generation to be performed for the load instruction.

The memory execution unit may receive either the predicted address 108 for the load instruction or the predicted value 110 for the load instruction. In the case of receiving the predicted value, the memory execution unit may execute the load operation (e.g., a decoded instruction decoded from the load instruction) to store the predicted value 114 in the destination register 116 indicated by the load instruction. Alternatively, in the case of receiving the predicted address, the memory execution unit may execute a load operation to load a value with the predicted address and store the loaded value 118 corresponding to the predicted address in the destination register 116 indicated by the load instruction. The memory execution unit may then wake up the dependent instructions (e.g., which may be stored in a reorder/schedule unit) of the load instruction and cause the load value to be forwarded to these dependent instructions so that they can begin to execute. In some embodiments, the memory execution unit, to load the value with the predicted address, may load or otherwise access the loaded value 122 from a cache hierarchy 124 with the predicted address 120 (e.g., if the value corresponding to the predicted address is stored in the cache hierarchy), or else may load or otherwise access the loaded value 122 from system memory with the predicted address 120 (e.g., if the value corresponding to the predicted address is not stored in the cache hierarchy). The cache hierarchy may have a plurality of caches at a plurality of different cache levels (e.g., an L1 cache, an L2 cache, optionally an L3 cache, etc.). In some embodiments, the memory execution unit may also optionally be able to obtain the load value from a store instruction in a buffer (e.g., in the case of store to load forwarding). Advantageously, the memory execution unit (e.g., part of the existing load pipeline) may be used as the mechanism to make the data or value available to dependent instructions (e.g., write the data or value in the destination register).

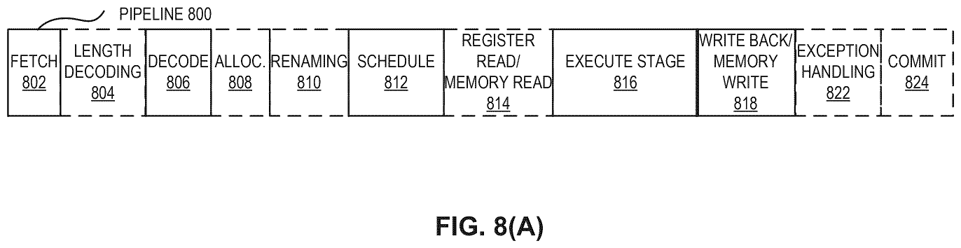

Examples of suitable memory execution units include, but are not limited to, load units, execution units able to execute load instructions, load/store units (LSUs), and execution units able to execute load and store instructions. One specific example of a suitable memory execution unit is the memory access circuitry 864 and/or a portion of the execution cluster 860 of FIG. 8(B), although the scope of the invention is not so limited. In some embodiments, the memory execution unit may optionally include at least one input structure (e.g., a port, interconnect, or interface) coupled to receive load operations and optionally store operations, a queue, buffer, or other storage (e.g., an incomplete load queue, etc.) to store the load operations and optionally the store operations, and at least one output structure (e.g., a port, interconnect, or interface) coupled therewith to output the load operations and optionally the store operations. In some embodiments, the memory execution unit may optionally include an address generation unit or circuitry. Alternatively, the address generation unit or circuitry may optionally be external to the memory execution unit. In some embodiments, the memory execution unit may include at least some hardware (e.g., transistors, circuitry, etc.). In some embodiments, the memory execution unit may be included within a die, integrated circuit, or semiconductor substrate.

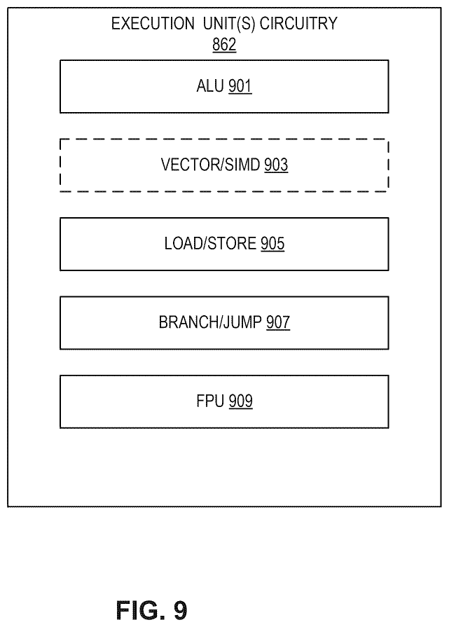

The destination register 116 may be one of a set of architecturally-visible or architectural registers that are visible to software and/or a programmer and/or are the registers indicated by instructions of the instruction set of the processor to identify operands. These architectural registers are contrasted to other non-architectural registers in a microarchitecture (e.g., temporary registers, reorder buffers, retirement registers, etc.). The destination register may be implemented in different ways in different microarchitectures and is not limited to any particular design. Examples of suitable destination registers include, but are not limited to, dedicated physical registers, dynamically allocated physical registers using register renaming, and combinations thereof. Specific examples of suitable registers for the destination register include, but are not limited to, the general purpose registers 1025 and the vector/SIMD registers 1010 of FIG. 10.

Providing the predicted address and/or the predicted value may help to hide latencies associated with performing the load instruction from other dependent instructions that directly or indirectly rely on the value loaded by the load instruction. The predicted address and/or the predicted value may be provided relatively soon (e.g., early in the pipeline) before the address has actually been generated, and in some cases even before the address generation information (e.g., the source operand of the load instruction) is available to be used. In some embodiments, this may be done right after allocation of the load instruction. The predicted address may be used to initiate a load of the value sooner, without waiting for the address to be generated. The predicted value may be provided to the dependent instructions sooner to allow them to begin executing, instead of having those dependent instructions stall waiting for the actual address to be generated and for the actual value to be loaded from the caches or system memory. In some embodiments, this may be done right after allocation of the load instruction. The ability to either load the value sooner with the predicted address, or to obtain the predicted value sooner, may help to reduce the performance limiting effect of data dependencies between the load instruction and its dependent instructions by allowing the dependent instructions to execute sooner via instruction level parallelism. This in turn may help to improve performance.

Advantageously, the combined address and value prediction unit is able to use both load address prediction to predict the address that would be generated for the load instruction and load value prediction to predict the value that would be loaded by the load instruction. The ability to do both load address prediction and load value prediction may be used to achieve more advantage than available by either approach alone (e.g., load address prediction can be used when it is most effective and load value prediction can be used when it is most effective). Correct value predictions tend to provide relatively greater performance improvement than correct address predictions. For example, this may be especially the case if a value corresponding to a predicted address is not cached in the cache hierarchy and needs to be loaded from memory. In this case, the longer latencies of loading the value from system memory may not be saved even if some benefit of correctly predicting the address is achieved. However, the proportion of loads that can be covered by correct value predictions tends to be less than the proportion that can be covered by correct address predictions. Using a combination of both load address prediction and load value prediction may help to offer the relatively greater performance improvements of correct value predictions where possible and to offer the greater coverage of correct address predictions otherwise.

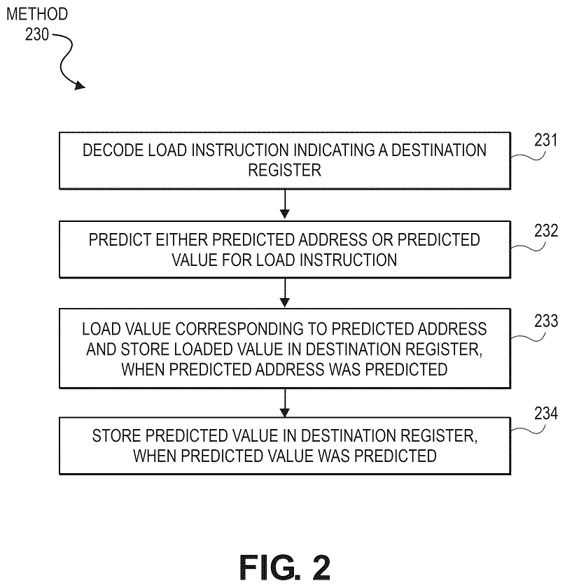

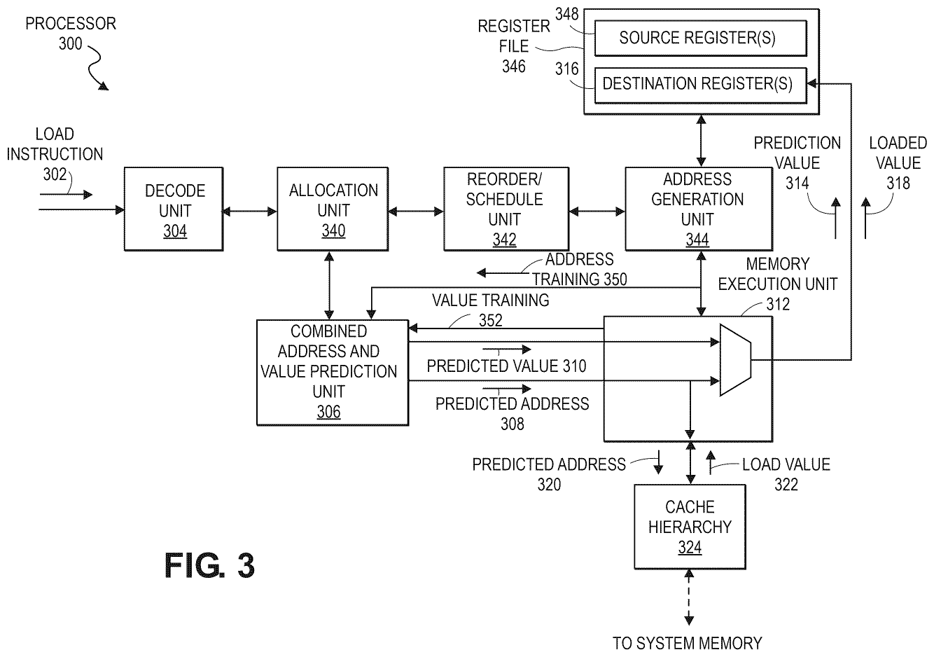

FIG. 2 is a block flow diagram of an embodiment of a method 230 predicting either an address or a value for a load instruction. In various embodiments, the method may be performed by a processor, digital logic device, or integrated circuit. In some embodiments, the method may be performed by the processor 100 of FIG. 1 or the processor 300 of FIG. 3. The components, features, and specific optional details described herein for the processor 100 and/or the processor 300 may optionally apply to the method 230. Alternatively, the method 230 may be performed by a similar or different processor or other apparatus. Moreover, the processor 100 and/or the processor 300 may perform methods the same as, similar to, or different than the method 230.

The method includes decoding a load instruction, at block 231. The load instruction indicates a destination register. Either a predicted address or a predicted value is predicted for the load instruction, at block 232. In some embodiments, this prediction may optionally be performed while a load operation corresponding to the load instruction is at allocation. In the case of predicting the predicted address, a value corresponding to the predicted address is loaded and then the loaded value is stored in the destination register, at block 233. In some embodiments, loading the value corresponding to the predicted address may include accessing the value from a cache hierarchy with the predicted address if the value corresponding to the predicted address is stored in the cache hierarchy or accessing the value from system memory if the value corresponding to the predicted address is not stored in the cache hierarchy. In the case of predicting the predicted value, the predicted value is stored in the destination register, at block 234.

FIG. 3 is a block diagram of a more detailed example embodiment of a processor 300 having a combined address and value prediction unit 306 to predict either an address 308 or a value 310 for a load instruction 302. The processor includes a decode unit 304 to decode the load instruction 302. The load instruction may specify or otherwise indicate a destination register 316 of the processor. The processor also includes the combined address and value prediction unit 306 to predict and provide either the address 308 or the value 310 for the load instruction. The processor also includes a memory execution unit 312 coupled with the combined address and value prediction unit 306. The memory execution unit (e.g., when the predicted address 308 is provided) is to load a value 322 corresponding to the predicted address 320 and store the loaded value 318 in the destination register. Alternatively, the memory execution unit (e.g., when the predicted value 310 is provided) is to store the predicted value 314 in the destination register. Unless otherwise specified below, the processor, the decode unit, the load instruction, the destination register, the combined address and value prediction unit, and the memory execution unit may optionally have some or all the characteristics of the correspondingly named components already described for FIG. 1. To avoid obscuring the description, the different and/or additional characteristics of the embodiment of FIG. 3 will primarily be described, without repeating the characteristics already described above for these components.

The processor includes an allocation unit 340. The allocation unit may exist at the allocation stage of the pipeline of the processor and may perform operations associated with assigning physical registers and other resources to the decoded instructions output from the decode unit. The allocation unit may include a queue, buffer, or other such storage (e.g., a decoded instruction queue) to store decoded instructions (e.g., microinstructions, micro-operations, etc.) waiting to be allocated.

The combined address and value prediction unit 306 may predict either an address or a value for the load instruction being allocated by the allocation unit (e.g., a load operation stored in the decoded instruction queue or other such storage of the allocation unit). That is, the combined address and value prediction unit may be deployed after the start of the allocation stage of the pipeline of the processor. Including the combined address and value prediction unit right after the allocation stage of the pipeline and/or doing the predictions right after allocation may tend to offer certain advantages such as a simpler implementation (e.g., by helping to reduce certain verifications that may otherwise be performed), although this is not required. When a prediction can be made, the combined address and value prediction unit may predict and output or provide either the predicted value 310 or the predicted address 308 for the load instruction.

Value predicted loads take be implemented as two passes through the memory execution unit. In the first pass, the predicted load value from the prediction unit may be written to the destination register by the memory execution unit and the dependent instructions may be woken up and executed. In this first pass, the load operation may not perform TLB address translation or L1 data cache lookups. In the second pass, a load-check operation may be performed by the memory execution unit only after the source operands are ready and the load address has been generated. In the second pass the load-check operation may behave more like a conventional demand load and it may perform TLB translation, address checks, store forwarding, and access the L1 data cache if needed. In the second pass, the load does not wake up its dependent or writeback's the value to its dependents. Then, the actual load value obtained via the second pass may be checked against the predicted load value from the first pass to verify the prediction correctness.

The memory execution unit 312 is coupled with the combined address and value prediction unit 306. The memory execution unit may receive either the predicted address 308 for the load instruction or the predicted value 310 for the load instruction. In the case of receiving the predicted value 310, the memory execution unit may execute a load operation (e.g., a decoded instruction decoded from the load instruction) to store the predicted value 314 in the destination register 316 indicated by the load instruction. Alternatively, in the case of receiving the predicted address 308, the memory execution unit may execute the load operation to load or otherwise obtain a loaded value 322 with the predicted address 320 and store the loaded value 318 corresponding to the predicted address 308 in the destination register 316 indicated by the load instruction. In some embodiments, to load or otherwise obtain the loaded value 322 with the predicted address 320, the memory execution unit may load or otherwise access the loaded value 322 from a cache hierarchy 324 with the predicted address 320 (e.g., if the value corresponding to the predicted address is stored in the cache hierarchy), or else may load or otherwise access the loaded value 322 from system memory with the predicted address 320 (e.g., if the value corresponding to the predicted address is not stored in the cache hierarchy). In some embodiments, the memory execution unit may also optionally be able to obtain the load value from a store instruction in a buffer (e.g., in the case of store to load forwarding).

In some embodiments, the memory execution unit may include a new queue, buffer, or other storage (e.g., a first in, first out (FIFO) prefetch queue) to buffer, queue, or store load operations. This new storage may be in addition to a conventional queue, buffer, or other storage (e.g., an incomplete load buffer) conventionally used to store load operations. Load operations predicted by the combined address and value prediction unit may be added to this new queue or other storage right after allocation when the predictions are made. This may include storing the predicted address or predicted value. In some embodiments, the oldest load operations from the head of the buffer may arbitrate for load ports in the memory execution unit with lower priority (e.g., lowest priority) relative to demand loads. When there are not enough demand loads to dispatch on a port in a cycle, the memory execution unit load port arbitration may dispatch these load operations predicted by the combined address and value prediction unit from the buffer. Alternatively, the predicted load operations may optionally be stored in the conventional storage (e.g., the incomplete load buffer).

Providing the predicted address and/or the predicted value may help to hide latencies associated with performing the load instruction from other dependent instructions that directly or indirectly rely on the value loaded by the load instruction. The predicted address and/or the predicted value may be provided relatively soon (e.g., early in the pipeline around the time of allocation) before the address has actually been generated, and in some cases even before the address generation information (e.g., the source operand of the load instruction) is available to be used. The predicted address may be used to initiate the load of the loaded value from the cache hierarchy or system memory sooner, without waiting for the address to be generated. The predicted value may be provided to the dependent instructions sooner to allow them to begin executing, instead of having those dependent instructions stall waiting for the actual address to be generated and for the loaded value to be loaded from the caches or system memory. The ability to either load the loaded value sooner using the predicted address, or to obtain the predicted value sooner, may help to reduce the performance limiting effect of data dependencies between the load instruction and its dependent instructions by allowing the dependent instructions to execute sooner via instruction level parallelism. This in turn may help to improve performance.

Now, the predicted address and the predicted value are predictions not actual correct values and they will not always be correct. In the case of a predicted address, the processor may need to actually generate the actual address for the load instruction in order to verify that the predicted address turns out to be correct (e.g., matches the actual or correct address generated for the load instruction). or verify that the predicted value turns out to be correct (e.g., matches the actual or correct value actually loaded through the execution of the load instruction). In the case of a predicted value, the processor may need to actually perform the load instruction in the second pass through the conventional slower path in order to verify that the predicted value turns out to be correct (e.g., matches the actual or correct value actually loaded through the execution of the load instruction).

The processor includes a reorder and schedule unit 342 coupled with the allocation unit. The decoded instructions from the allocation unit may be provided to the reorder and schedule unit. The reorder and schedule unit may store the decoded instructions, schedule the decoded instructions for out-of-order execution, and assist with reordering the decoded instructions back into original program order. As one example, the reorder and schedule unit may include a reorder buffer (ROB), a reservation station, and a scheduler unit, although the scope of the invention is not limited in this regard. Other ways of providing an instruction window may also optionally be used.

An address generation unit 344 is coupled with the reorder and schedule unit. The address generation unit may generate an address (e.g., virtual memory address) for the load instruction. In some cases, the load instruction 304 may indicate one or more source registers 348 in a register file 346 that store address generation information for the load instruction. The address generation unit may be coupled with the register file and/or such source registers to receive the address generation information. The address generation unit may use the address generation information to generate an address for the load instruction. The address generation unit may need to wait to receive the address generation information, and therefore need to wait to generate the address, until the source registers are ready (e.g., free of conflicts). The dependent instructions of the load instruction may also need to wait. This waiting tends to limit performance and can be at least partially mitigated when correct address predictions can be made.

The address generation unit may output the generated load address for the load instruction. The generated load address may be provided to the combined address and value prediction unit as address training information 350. The combined address and value prediction unit may use the generated load address as an actual or correct load address to train or inform its load address prediction mechanism or capabilities. This will be discussed in further detail below.

If the predicted address does not match the actual or correct address, then all results generated based on the associated incorrectly loaded value may also be incorrect and may need to be discarded (e.g., a pipeline nuke may be performed). An actual or correct load value obtained using the actual or correct address may be obtained, written to the destination register indicated by the load instruction, and dependent instructions of the load instruction may be re-executed based on actual or correct load value.

The memory execution unit 312 is coupled with the address generation unit. The memory execution unit may receive addresses generated by the address generation unit for memory access instructions. In the case of the load instruction 302, the memory execution unit may receive the generated load address. The memory execution unit may load a value or data from the generated load address. The memory execution unit is coupled with a cache hierarchy 324. The memory execution unit may check the cache hierarchy to see if the value or data is already stored in the cache hierarchy for the generated load address. If not, the memory execution unit may load the value or data from the generated load address in system memory.

In the case of the predicted value 310 being output from the combined address and value prediction unit, the combined address and value prediction unit and/or the processor may check that the predicted value matches the more slowly obtained actual or correct load value loaded based on the actual or correct generated address from the address generation unit. In order for the predicted value to be correct, it should match this more slowly obtained actual or correct load value.

If the predicted value matches the actual value, then the correct value was already written to the destination register for the load instruction and the dependent instructions of the load instruction relied upon a correct value. However, if the predicted value does not match the actual value, then an incorrect value was written to the destination register for the load instruction and the dependent instructions of the load instruction relied upon the incorrect value. In the latter case, all results generated based on the incorrect value may also be incorrect and may need to be discarded (e.g., a pipeline nuke may be performed). The now more slowly determined actual or correct load value may be written to the destination register indicated by the load instruction and dependent instructions of the load instruction may be re-executed based on this more slowly determined actual or correct load value.

The more slowly determined actual or correct load value may also be provided to the combined address and value prediction unit as value training information 352. The combined address and value prediction unit may use the more slowly determined actual or correct load value to train or inform its load value prediction mechanism or capabilities. This will be discussed in further detail below.

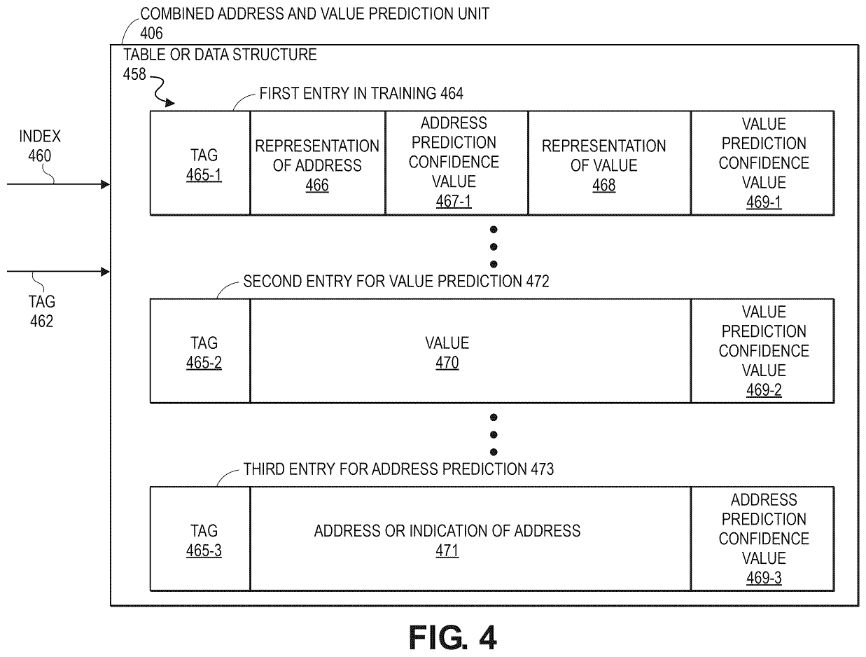

FIG. 4 is a block diagram of a detailed example embodiment of a combined address and value prediction unit 406 to predict either an address or a value for a load instruction. In some embodiments, the combined address and value prediction unit 406 may be used as the combined address and value prediction unit 106 of FIG. 1 or as the combined address and value prediction unit 306 of FIG. 3. Alternatively, the combined address and value prediction unit 406 may be used in other processors or arrangements. Unless otherwise specified below, the combined address and value prediction unit 406 may optionally have some or all the characteristics of the correspondingly named components already described for the prediction unit 106 and/or the prediction unit 306. To avoid obscuring the description, the different and/or additional characteristics of the embodiment of FIG. 4 will primarily be described, without repeating the characteristics already described above.

In some embodiments, the combined address and value prediction unit may be implemented as a table or other data structure 458 having a plurality of entries. In some embodiments, the combined address and value prediction unit may be implemented as a set associative table or data structure (e.g., an N-way set associative table or data structure) having a plurality of entries. Alternatively, the combined address and value prediction unit may be implemented as a direct mapped table or other structure, a fully-associative table or other structure, a simple table, a table indexed through more complex hash functions, or in other ways. As one specific embodiment, the predictor may have up to several kilobytes of storage arranged in multiple ways (e.g., 2-8 ways) and multiple banks (e.g., 2-8 banks where each bank has multiple ports (e.g., 2-3 ports), although the scope of the invention is not so limited.

The predictor may store different entries to be used for different load instructions. The different entries may be indexed or selected by an index 460 and a tag 462 generated for the load instructions. By way of example, the index may select a set and the tag may select a way within the set. In some embodiments, the index 460 may be a value representing a combination of an instruction pointer (sometimes referred to as a program counter) for a load instruction and branch history information (e.g., of the type sometimes referred to as stew) for the load instruction. By way of example, the combination may include at least some bits (e.g., from around one or two bytes of lowest order bits) of the instruction pointer exclusive OR'd (XOR'd) or otherwise combined with at least some bits (e.g., lowest order bits) of branch history information (e.g., around one or two bytes of lowest order bits of stew). Other ways of combining the instruction pointer information and the branch history information may also optionally be used. The combination of the instruction pointer and the branch history information may serve as an identifier for the load instruction to select an appropriate entry. Incorporating the branch history information helps to allow predictions to be made independently not only for different load instructions at different instruction pointers but also for different instances of an instruction at a given instruction pointer during different iterations of a loop. In some embodiments, the tag 462 may be a value representing some of the bits of the instruction pointer for the load instruction (e.g., from about 7-bits to about 15-bits of the most significant bits used to generate the index). When a load instruction is allocated, the index and the tag for the load instruction may be used to check the predictor and select an entry in the predictor.

In the illustration, three different types of entries are shown, although it is to be appreciated that there may be many more entries. The three different types of entries include a first entry for training 464. The first entry represents an entry that is being trained for both address and value prediction but not yet ready for either address or value prediction. The first entry has a field or set of bits for a tag 465-1, a field or set of bits for a representation of an address 466, a field or set of bits for an address prediction confidence value 467-1, a field or set of bits for a representation of a value 468, and a field or set of bits for a value prediction confidence value 469-1.

The tag 465-1 may be selected by (e.g., based on a match) the tag 462 generated for the load instruction for which a prediction is to be made. The representation of the address 466, and the representation of the value 468, may either be the actual address and the actual value, or a hash or other representation of the actual address and a hash or other representation of the actual value. One reason to use such a hash or other representation is to represent the address and value in fewer bits than would be needed to store the actual address and the actual value. For example, the hash may have from around 8-bits to 20-bits (or optionally more if desired) whereas the actual value may in some cases have 32-bits or more and the actual address may often have 32-bits or more and often many more bits. Alternatively, the actual address and/or the actual value may optionally be stored if desired.

The address prediction confidence value 467-1 and the value prediction confidence value 469-1 may each represent a value indicating or representative of the expected prediction accuracy of the representation of the address and the representation of the value, respectively. By way of example, each of these confidence values may have from about 2-bits to about 8-bits. The prediction unit may include circuitry to maintain, update, or train the address prediction confidence value and the value prediction confidence value. By way of example, the circuitry may maintain, update, or train the address prediction confidence value to reflect and/or based on whether previously predicted addresses for previous instances of the load instruction (e.g., with the same index and tag) were predicted correctly. Likewise, the circuitry may maintain, update, or train the value prediction confidence value to reflect and/or based on whether previously predicted values for the previous instances of the load instruction (e.g., with the same index and tag) were predicted correctly.

On every load writeback, the circuitry and/or the prediction unit may check if the actual address and/or the actual value (or their hashes or other representations as previously described) equal or otherwise match the representation of the address and/or the representation of the value reflected in the predictor for the associated load instruction. If they are equal or otherwise match, then the associated address prediction confidence value and/or value prediction confidence value may be incremented or otherwise increased. If they are not equal or otherwise do not match, then the associated address prediction confidence value and/or value prediction confidence value may be decremented or otherwise decreased. If the address prediction confidence value and/or value prediction confidence value becomes low enough (e.g., zero or another lower threshold), then the entry may optionally be selected for removal from the predictor. If the address prediction confidence value and/or value prediction confidence value becomes high enough (e.g., from about 4-16 or some other upper threshold), then the entry may optionally be selected to be used for address and/or value prediction. In such cases, the actual address or value may be stored to the entry and used for the load instruction and subsequent instances of the load instruction (e.g., having the same instruction pointer and branch history information).

Referring again to FIG. 4, the second entry 472 represents an entry that is ready to be used for value prediction. The second entry has a field or set of bits for a tag 456-2, a field or set of bits for a value 470, and a field or set of bits for a value prediction confidence value 469-2. The tag and the value prediction confidence value may be similar to or the same as those described above for the first entry 464. The value 470 may be the actual value instead of a hash thereof. The value prediction confidence value may continue to be updated for value predictions based on whether the predicted values match the actual values and if the value prediction confidence value decreases below a level or threshold then the second entry may no longer be used for value prediction (e.g., may be selected for eviction).

The third entry 473 represents an entry that is ready to be used for address prediction. The third entry has a field or set of bits for a tag 456-3, a field or set of bits for either an address or an indication of an address 471, and a field or set of bits for an address prediction confidence value 467-3. The tag and the address prediction confidence value may be similar to or the same as those described above for the first entry 464. In some embodiments, the actual address may optionally be stored in the field or set of bits. In other embodiments, information sufficient to indicate the address may optionally be stored in the field or set of bits. One example of such information is a field or set of bits to indicate a way in a translation lookaside buffer (TLB) storing the address, a field or set of bits to indicate a set in the TLB storing the address, and a field or set of bits storing a subset of the bits (e.g., least significant bits) of the address. Such information may be used to select the address from the TLB. The address prediction confidence value may continue to be updated for address predictions based on whether the predicted addresses match the actual addresses and if the addresses prediction confidence value decreases below a level or threshold then the third entry may no longer be used for addresses prediction (e.g., may be selected for eviction).

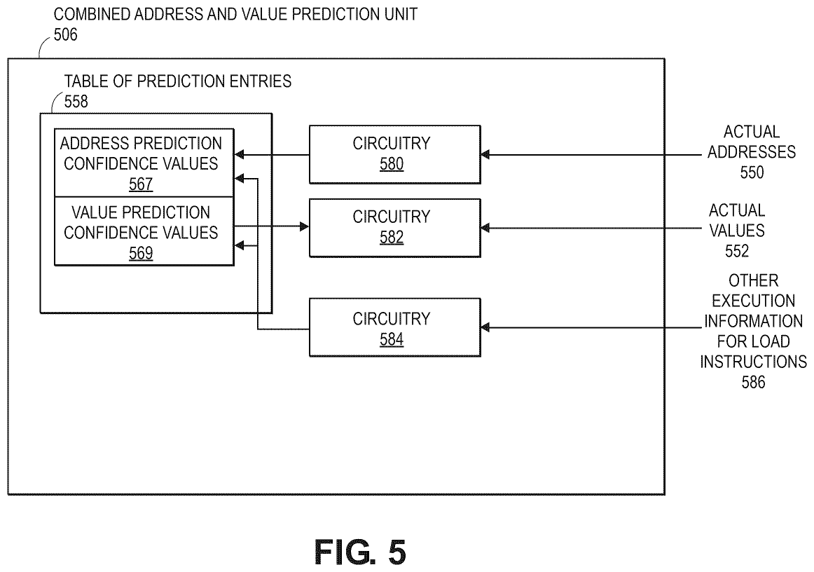

FIG. 5 is a block diagram of an embodiment of a combined address and value prediction unit to dynamically determine whether to predict addresses or values for load instructions. The prediction unit includes a table of prediction entries 558. The table includes address prediction confidence values 567 and value prediction confidence values 569. These may be analogous to those described for FIG. 4. The prediction unit includes circuitry 580 to update, maintain, or change the address prediction confidence values 567 based on whether previously predicted addresses for previous instances of load instructions match actual addresses 550 and/or whether or not the previously predicted addresses were correctly predicted. The prediction unit includes circuitry 582 to update, maintain, or change the value prediction confidence values 569 based on whether previously predicted values for previous instances of load instructions match actual values 552 and/or whether or not the previously predicted values were correctly predicted.

The prediction unit also includes circuitry 584 to update, maintain, or change the address prediction confidence values 567 and/or the value prediction confidence values 569 based on other information 586 learned, observed, or monitored about the execution of the previous instances of load instructions. That is, in some embodiments, the circuitry 584 may help the prediction unit decide between making address predictions and making value predictions based in part on such other information 586. This other information may include characteristics, properties, or attributes associated with the execution of the load instructions other than the actual addresses and actual values. Examples of such other information include, but are not limited to, whether the load instructions hit or missed in the L1 caches, whether the load instructions hit or missed in the cache hierarchy, how long the actual load instructions took to complete, whether the load instructions stalled on store instructions, other information about how the load instructions actually executed, etc.

Based on such information, the circuitry 584 may influence whether address prediction or value prediction is used. For example, if a load took a long time to complete (e.g., it missed in the L1 cache, stalled on a store, etc.), then the circuitry 584 may emphasize value prediction over address prediction, even if both the predicted address and the predicted value were predicted correctly. Since the address prediction didn't offer as much performance increase as desired, the value prediction may be selectively emphasized over address prediction (e.g., the value prediction confidence may be selectively increased without increasing the address prediction confidence, the value prediction confidence may be selectively increased more than the address prediction confidence, etc.). As another example, if a load did not take a long time to complete (e.g., it hit in the L1 cache and did not stall on a store), then such circuitry 584 may emphasize address prediction over value prediction, even if both the predicted address and the predicted value were predicted correctly. Since the address prediction offered a significant performance increase, the address prediction may be selectively emphasized over value prediction (e.g., the address prediction confidence may be selectively increased without increasing the value prediction confidence, the address prediction confidence may be selectively increased more than the value prediction confidence, etc.).

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are suitable.

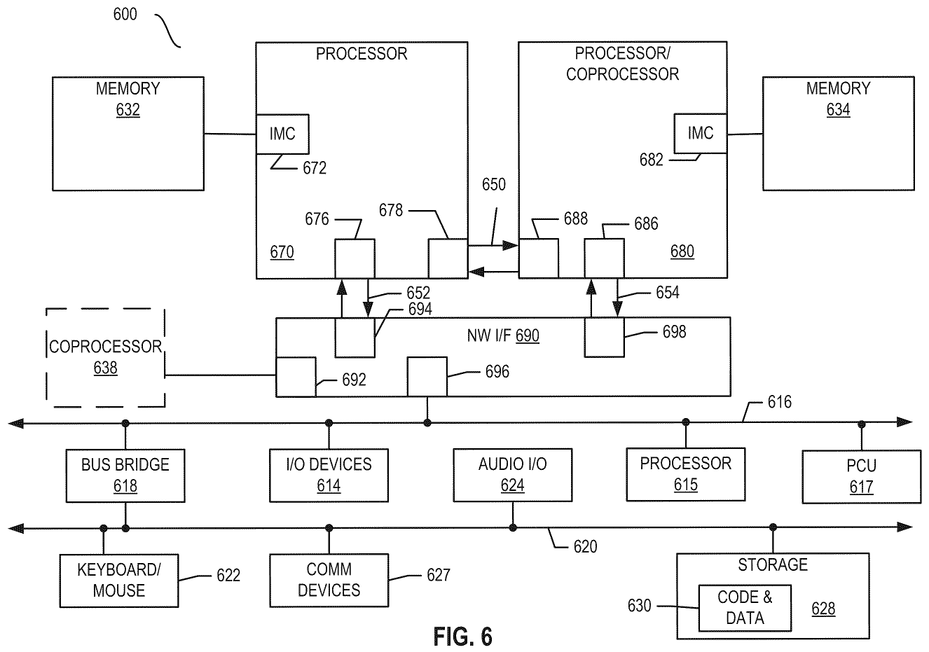

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, the first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, the first interface 616 may be an interface such as a Peripheral Component Interconnect (PCI) interconnect, a PCI Express interconnect or another I/O interconnect. In some examples, the first interface 616 is coupled to a power control unit (PCU) 617, which may include circuitry, software, and/or firmware to perform power management operations regarding the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, the second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage 'ISAB03 in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

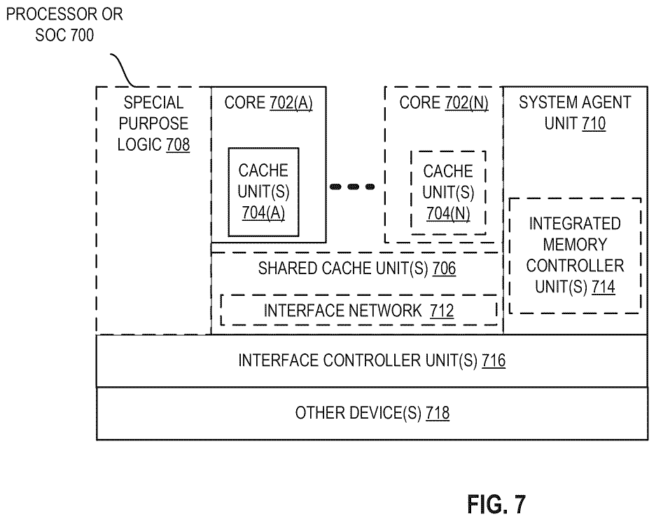

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of several process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

### Example Core Architectures—In-Order and Out-of-Order Core Block Diagram.

FIG. 8(A) is a block diagram illustrating both an example in-order pipeline and an example register renaming, out-of-order issue/execution pipeline according to examples. FIG. 8(B) is a block diagram illustrating both an example in-order architecture core and an example register renaming, out-of-order issue/execution architecture core to be included in a processor according to examples. The solid lined boxes in FIGS. 8(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8(A), a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 8(B) may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8(B) shows a processor core 890 including front-end unit circuitry 830 coupled to execution engine unit circuitry 850, and both are coupled to memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front-end unit circuitry 830 may include branch prediction circuitry 832 coupled to instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front-end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, address generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include several execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to data cache circuitry 874 coupled to level 2 (L2) cache circuitry 876. In one example, the memory access circuitry 864 may include load unit circuitry, store address unit circuitry, and store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Example Execution Unit(s) Circuitry.

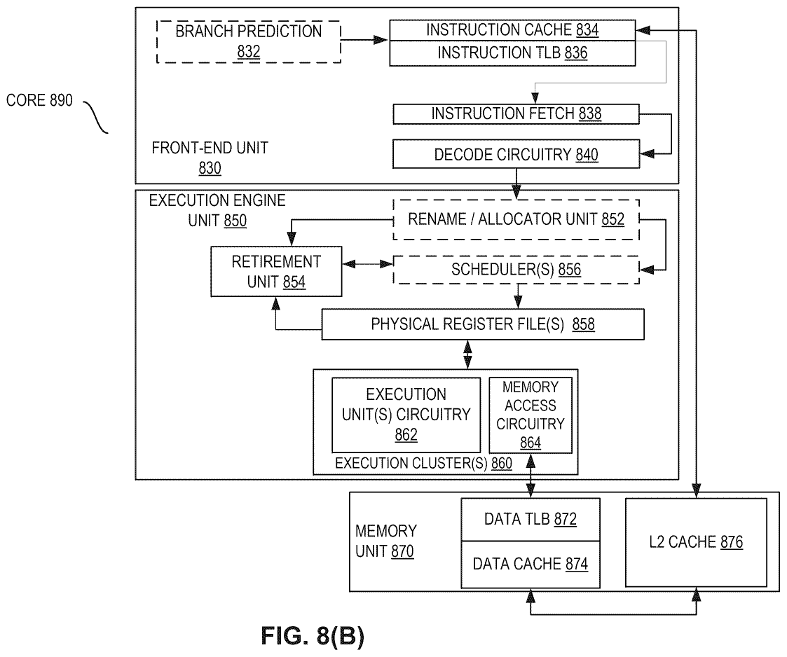

FIG. 9 illustrates examples of execution unit(s) circuitry, such as execution unit(s) circuitry 862 of FIG. 8(B). As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register file 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1000 may, for example, be used in register file/memory 'ISAB08, or physical register file(s) circuitry 8 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

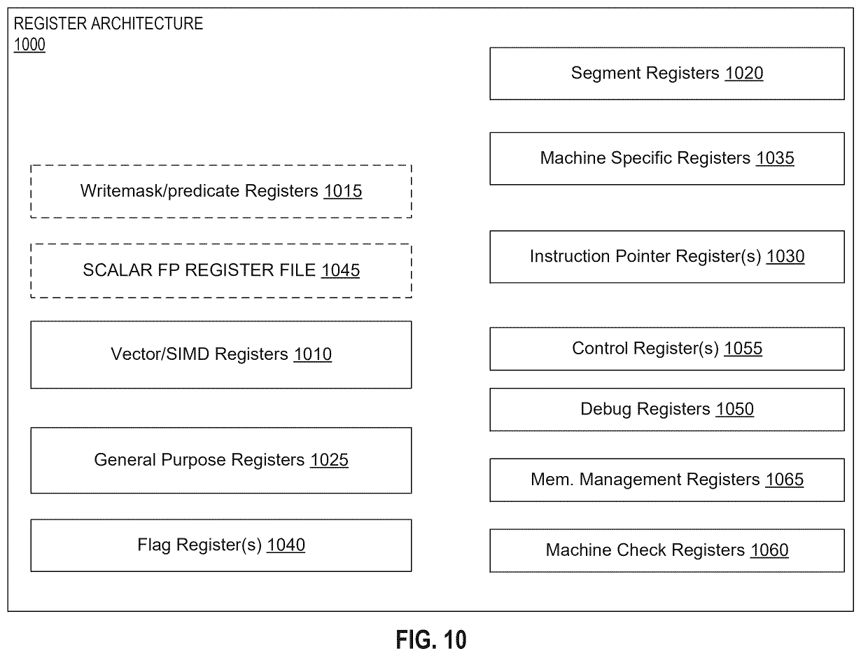

FIG. 11 illustrates examples of an instruction format. As illustrated, an instruction may include multiple components including, but not limited to, one or more fields for: one or more prefixes 1101, an opcode 1103, addressing information 1105 (e.g., register identifiers, memory addressing information, etc.), a displacement value 1107, and/or an immediate value 1109. Note that some instructions utilize some or all the fields of the format whereas others may only use the field for the opcode 1103. In some examples, the order illustrated is the order in which these fields are to be encoded, however, it should be appreciated that in other examples these fields may be encoded in a different order, combined, etc.

The prefix(es) field(s) 1101, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1103 is used to at least partially define the operation to be performed upon a decoding of the instruction. In some examples, a primary opcode encoded in the opcode field 1103 is one, two, or three bytes in length. In other examples, a primary opcode can be a different length. An additional 3-bit opcode field is sometimes encoded in another field.

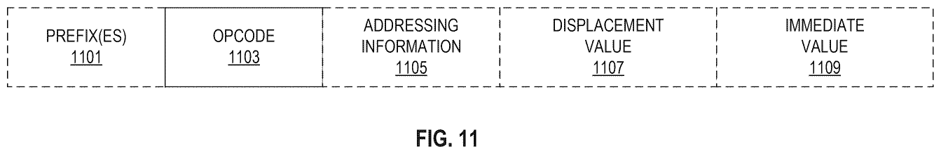

The addressing information field 1105 is used to address one or more operands of the instruction, such as a location in memory or one or more registers. FIG. 12 illustrates examples of the addressing information field 1105. In this illustration, an optional MOD R/M byte 1202 and an optional Scale, Index, Base (SIB) byte 1204 are shown. The MOD R/M byte 1202 and the SIB byte 1204 are used to encode up to two operands of an instruction, each of which is a direct register or effective memory address. Note that both fields are optional in that not all instructions include one or more of these fields. The MOD R/M byte 1202 includes a MOD field 1242, a register (reg) field 1244, and R/M field 1246.

The content of the MOD field 1242 distinguishes between memory access and non-memory access modes. In some examples, when the MOD field 1242 has a binary value of 11 (11b), a register-direct addressing mode is utilized, and otherwise a register-indirect addressing mode is used.

The register field 1244 may encode either the destination register operand or a source register operand or may encode an opcode extension and not be used to encode any instruction operand. The content of register field 1244, directly or through address generation, specifies the locations of a source or destination operand (either in a register or in memory). In some examples, the register field 1244 is supplemented with an additional bit from a prefix (e.g., prefix 1101) to allow for greater addressing.

The R/M field 1246 may be used to encode an instruction operand that references a memory address or may be used to encode either the destination register operand or a source register operand. Note the R/M field 1246 may be combined with the MOD field 1242 to dictate an addressing mode in some examples.

The SIB byte 1204 includes a scale field 1252, an index field 1254, and a base field 1256 to be used in the generation of an address. The scale field 1252 indicates a scaling factor. The index field 1254 specifies an index register to use. In some examples, the index field 1254 is supplemented with an additional bit from a prefix (e.g., prefix 1101) to allow for greater addressing. The base field 1256 specifies a base register to use. In some examples, the base field 1256 is supplemented with an additional bit from a prefix (e.g., prefix 1101) to allow for greater addressing. In practice, the content of the scale field 1252 allows for the scaling of the content of the index field 1254 for memory address generation (e.g., for address generation that uses 2scale*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1107 provides this value. Additionally, in some examples, a displacement factor usage is encoded in the MOD field of the addressing information field 1105 that indicates a compressed displacement scheme for which a displacement value is calculated and stored in the displacement field 1107.

In some examples, the immediate value field 1109 specifies an immediate value for the instruction. An immediate value may be encoded as a 1-byte value, a 2-byte value, a 4-byte value, etc.

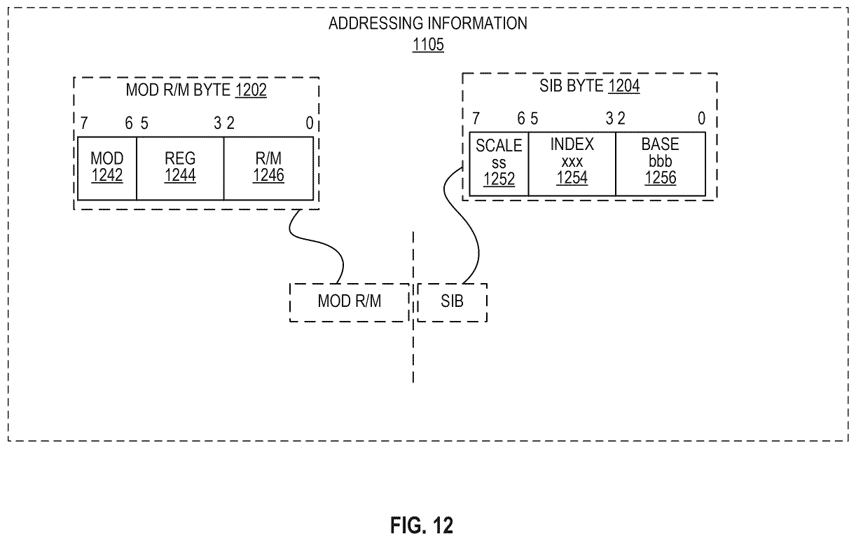

FIG. 13 illustrates examples of a first prefix 1101(A). In some examples, the first prefix 1101(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1101(A) may specify up to three registers using 3-bit fields depending on the format: 1) using the reg field 1244 and the R/M field 1246 of the MOD R/M byte 1202; 2) using the MOD R/M byte 1202 with the SIB byte 1204 including using the reg field 1244 and the base field 1256 and index field 1254; or 3) using the register field of an opcode.

In the first prefix 1101(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1244 and MOD R/M R/M field 1246 alone can each only address 8 registers.

In the first prefix 1101(A), bit position 2 (R) may be an extension of the MOD R/M reg field 1244 and may be used to modify the MOD R/M reg field 1244 when that field encodes a general-purpose register, a 64-bit packed data register (e.g., a SSE register), or a control or debug register. R is ignored when MOD R/M byte 1202 specifies other registers or defines an extended opcode.

Bit position 1 (X) may modify the SIB byte index field 1254.

Bit position 0(B) may modify the base in the MOD R/M R/M field 1246 or the SIB byte base field 1256; or it may modify the opcode register field used for accessing general purpose registers (e.g., general purpose registers 1025).

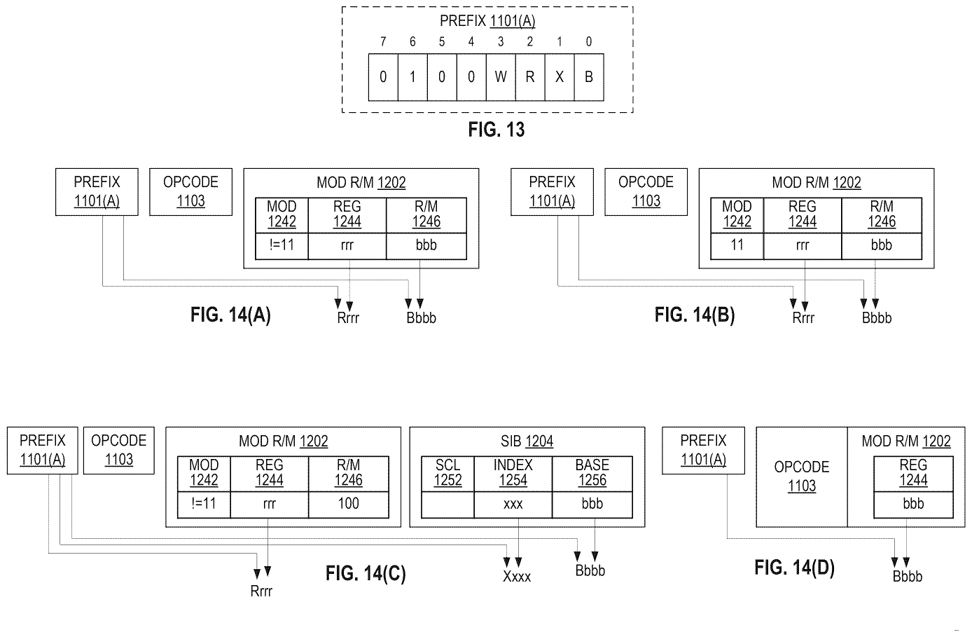

FIGS. 14(A)-(D) illustrate examples of how the R, X, and B fields of the first prefix 1101(A) are used. FIG. 14(A) illustrates R and B from the first prefix 1101(A) being used to extend the reg field 1244 and R/M field 1246 of the MOD R/M byte 1202 when the SIB byte 12 04 is not used for memory addressing. FIG. 14(B) illustrates R and B from the first prefix 1101(A) being used to extend the reg field 1244 and R/M field 1246 of the MOD R/M byte 1202 when the SIB byte 12 04 is not used (register-register addressing). FIG. 14(C) illustrates R, X, and B from the first prefix 1101(A) being used to extend the reg field 1244 of the MOD R/M byte 1202 and the index field 1254 and base field 1256 when the SIB byte 12 04 being used for memory addressing. FIG. 14 (D) illustrates B from the first prefix 1101(A) being used to extend the reg field 1244 of the MOD R/M byte 1202 when a register is encoded in the opcode 1103.

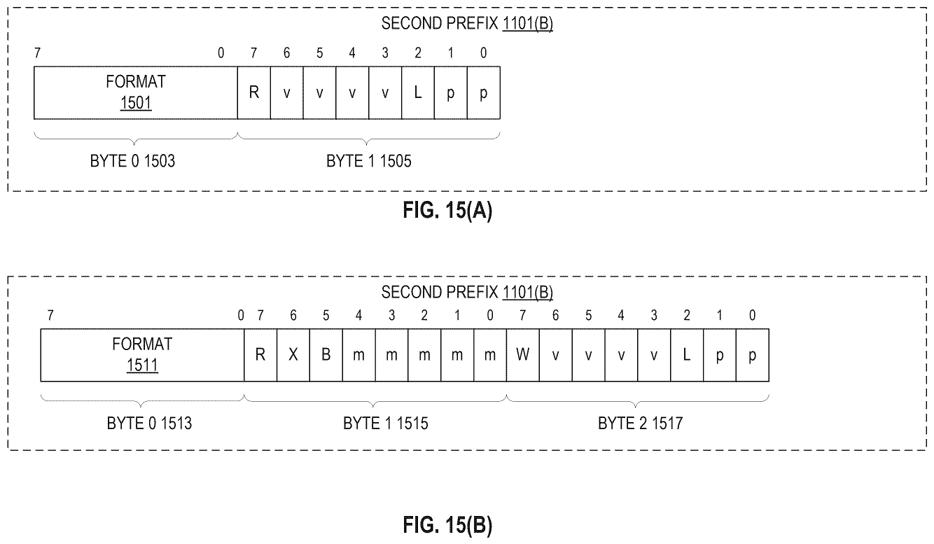

FIGS. 15(A)-(B) illustrate examples of a second prefix 1101(B). In some examples, the second prefix 1101(B) is an example of a VEX prefix. The second prefix 1101(B) encoding allows instructions to have more than two operands, and allows SIMD vector registers (e.g., vector/SIMD registers 1010) to be longer than 64-bits (e.g., 128-bit and 256-bit). The use of the second prefix 1101(B) provides for three-operand (or more) syntax. For example, previous two-operand instructions performed operations such as A=A+B, which overwrites a source operand. The use of the second prefix 1101(B) enables operands to perform nondestructive operations such as A=B+C.

In some examples, the second prefix 1101(B) comes in two forms-a two-byte form and a three-byte form. The two-byte second prefix 1101(B) is used mainly for 128-bit, scalar, and some 256-bit instructions; while the three-byte second prefix 1101(B) provides a compact replacement of the first prefix 1101(A) and 3-byte opcode instructions.

FIG. 15(A) illustrates examples of a two-byte form of the second prefix 1101(B). In one example, a format field 1501 (byte 0 1503) contains the value C5H. In one example, byte 1 1505 includes an “R” value in bit[7]. This value is the complement of the “R” value of the first prefix 1101(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246 and the MOD R/M reg field 1244 encode three of the four operands. Bits[7:4] of the immediate value field 1109 are then used to encode the third source register operand.

FIG. 15(B) illustrates examples of a three-byte form of the second prefix 1101(B). In one example, a format field 1511 (byte 0 1513) contains the value C4H. Byte 1 1515 includes in bits[7:5] “R,” “X,” and “B” which are the complements of the same values of the first prefix 1101(A). Bits[4:0] of byte 1 1515 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 1517 is used like W of the first prefix 1101(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246, and the MOD R/M reg field 1244 encode three of the four operands. Bits[7:4] of the immediate value field 1109 are then used to encode the third source register operand.

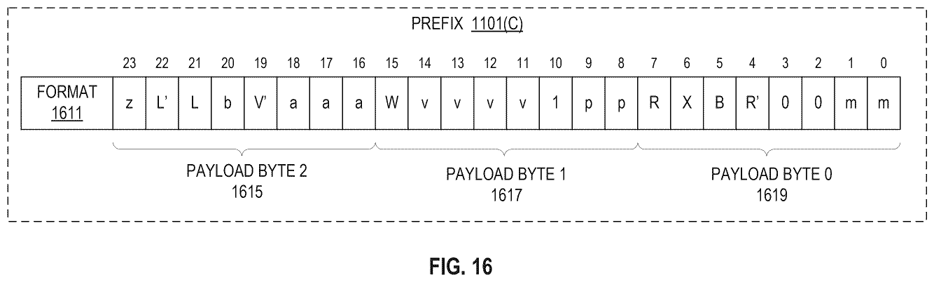

FIG. 16 illustrates examples of a third prefix 1101(C). In some examples, the third prefix 1101(C) is an example of an EVEX prefix. The third prefix 1101(C) is a four-byte prefix.

The third prefix 1101(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 10) or predication utilize this prefix. Opmask register allows for conditional processing or selection control. Opmask instructions, whose source/destination operands are opmask registers and treat the content of an opmask register as a single value, are encoded using the second prefix 1101(B).

The third prefix 1101(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1101(C) is a format field 1611 that has a value, in one example, of 62H. Subsequent bytes are referred to as payload bytes 1615-1619 and collectively form a 24-bit value of P[23:0] providing specific capability in the form of one or more fields (detailed herein).

In some examples, P[1:0] of payload byte 1619 are identical to the low two mm bits. P[3:2] are reserved in some examples. Bit P[4] (R′) allows access to the high 16 vector register set when combined with P[7] and the MOD R/M reg field 1244. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1244 and MOD R/M R/M field 1246. P[9:8] provides opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is like W of the first prefix 1101(A) and second prefix 1111(B) and may serve as an opcode extension bit or operand size promotion.

P[18:16] specify the index of a register in the opmask (writemask) registers (e.g., writemask/predicate registers 1015). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1101(C) are detailed in the following tables.

TABLE 1
32-Register Support in 64-bit Mode

| | | | | | COMMON |
|---|---|---|---|---|---|
| | 4 | 3 | [2:0] | REG. TYPE | USAGES |
| REG | R′ | R | MOD R/M reg | GPR, Vector | Destination or |
| | | | | | Source |
| VVVV | V′ | vvvv | | GPR, Vector | 2nd Source or |
| | | | | | Destination |
| RM | X | B | MOD R/M R/M | GPR, Vector | 1st Source or |
| | | | | | Destination |
| BASE | 0 | B | MOD R/M R/M | GPR | Memory addressing |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

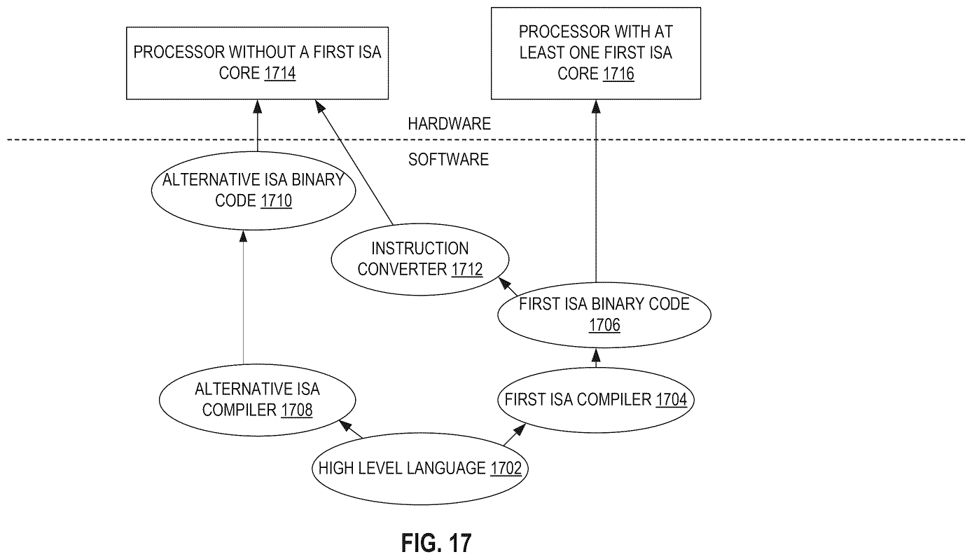

FIG. 17 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 17 shows a program in a high-level language 1702 may be compiled using a first ISA compiler 1704 to generate first ISA binary code 1706 that may be natively executed by a processor with at least one first ISA core 1716. The processor with at least one first ISA core 1716 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1704 represents a compiler that is operable to generate the first ISA binary code 1706 (e.g., object code) that can, with or without additional linkage processing, be executed on the processor with at least one first ISA core 1716. Similarly, FIG. 17 shows the program in the high-level language 1702 may be compiled using an alternative ISA compiler 1708 to generate alternative ISA binary code 1710 that may be natively executed by a processor without a first ISA core 1714. The instruction converter 1712 is used to convert the first ISA binary code 1706 into code that may be natively executed by the processor without a first ISA core 1714. This converted code is not necessarily to be the same as the alternative ISA binary code 1710; however, the converted code will accomplish the general operation and be made up of instructions from the alternative ISA. Thus, the instruction converter 1712 represents software, firmware, hardware, or a combination thereof that, through emulation, simulation, or any other process, allows a processor or other electronic device that does not have a first ISA processor or core to execute the first ISA binary code 1706.

Components, features, and details described for any of FIGS. 3-5 may also optionally apply to any of FIGS. 1-2. Components, features, and details described for any of the processors disclosed herein (e.g., processors 100, 300) may optionally apply to any of the methods disclosed herein (e.g., method 230), which in embodiments may optionally be performed by and/or with such processors. Any of the processors described herein in embodiments may optionally be included in any of the systems disclosed herein. Any of the processors disclosed herein may optionally have any of the microarchitectures shown herein.

References to “one example,” “an example,” etc., indicate that the example described may include a particular feature, structure, or characteristic, but every example may not necessarily include the particular feature, structure, or characteristic. Moreover, such phrases do not necessarily refer to the same example. Further, when a particular feature, structure, or characteristic is described in connection with an example, it is submitted that it is within the knowledge of one skilled in the art to affect such feature, structure, or characteristic in connection with other examples whether explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, yet still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals-such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

### EXAMPLE EMBODIMENTS

The following examples pertain to further embodiments. Specifics in the examples may be used anywhere in one or more embodiments.

Example 1 is a processor or other apparatus including a decode unit to decode a load instruction, the load instruction to indicate a destination register, a prediction unit to provide either a predicted address or a predicted value for the load instruction, and a memory execution unit coupled with the prediction unit, the memory execution unit to: (1) load a value corresponding to the predicted address and store the loaded value in the destination register; or (2) store the predicted value in the destination register.

Example 2 includes the processor of Example 1, where the prediction unit is to dynamically determine whether to provide the predicted address or the predicted value based at least in part on whether previously predicted addresses for previous instances of the load instruction were predicted correctly and/or whether previously predicted values for the previous instances of the load instruction were predicted correctly.

Example 3 includes the processor of any one of Examples 1 to 2, where the prediction unit is to dynamically determine whether to provide the predicted address or the predicted value based at least in part on a characteristic of an access for a value with one of the previously predicted addresses.

Example 4 includes the processor of Example 3, where the characteristic is selected from a group consisting of a length of time to complete the access for the value, whether there was a hit in a Level 1 (L1) cache during the access for the value, whether there was a hit in a cache hierarchy during the access for the value, and whether the access for the value stalled on a store.

Example 5 includes the processor of any one of Examples 1 to 4, where the prediction unit includes circuitry to maintain an address prediction confidence value that reflects whether previously predicted addresses for previous instances of the load instruction were predicted correctly and/or circuitry to maintain a value prediction confidence value that reflects whether previously predicted values for the previous instances of the load instruction were predicted correctly.

Example 6 includes the processor of any one of Examples 1 to 5, where the prediction unit is to provide either the predicted address or the predicted value after allocation of one or more decoded instructions decoded from the load instruction and/or before an actual address has been generated for the load instruction.

Example 7 includes the processor of any one of Examples 1 to 6, further including a cache hierarchy having a plurality of caches at a plurality of different levels. Also, optionally where the memory execution unit, to load the value corresponding to the predicted address, is to access the value from the cache hierarchy with the predicted address (e.g., after allocation of one or more decoded instructions corresponding to the load instruction and/or before an actual address has been generated based on address generation information associated with the load instruction), if the value corresponding to the predicted address is stored in the cache hierarchy and/or access the value from system memory with the predicted address if the value corresponding to the predicted address is not stored in the cache hierarchy.

Example 8 includes the processor of any one of Examples 1 to 7, where the prediction unit is to identify the load instruction based on a combination of an instruction pointer for the load instruction and branch history information for the load instruction.

Example 9 includes the processor of any one of Examples 1 to 8, where the prediction unit includes a table having a plurality of entries. Optionally, where a first entry of the plurality of entries is to be selected for the load instruction based on a combination of an instruction pointer for the load instruction and branch history information for the load instruction. Optionally, where the first entry is to store either the predicted value for the load instruction if the predicted value is to be provided or one of the predicted address or an indication of the predicted address if the predicted address is to be provided.

Example 10 includes the processor of Example 9, where a second entry of the plurality of entries is to be selected for a second load instruction based on a combination of an instruction pointer for the second load instruction and branch history information for the second load instruction. Optionally, where the second entry is to store a representation of a predicted address for the second load instruction, an address prediction confidence value corresponding to the representation of the predicted address, a representation of a predicted value for the second load instruction, and a value prediction confidence value corresponding to the representation of the predicted value.

Example 11 is a method (e.g., performed by a processor or other apparatus) including decoding a load instruction, the load instruction indicating a destination register, predicting either a predicted address or a predicted value for the load instruction, and loading a value corresponding to the predicted address and storing the loaded value in the destination register, in the case of predicting the predicted address, or storing the predicted value in the destination register, in the case of predicting the predicted value.

Example 12 includes the method of Example 11, further including dynamically determining whether to predict the predicted address or the predicted value based at least in part on whether previously predicted addresses for previous instances of the load instruction were predicted correctly and whether previously predicted values for the previous instances of the load instruction were predicted correctly.

Example 13 includes the method of any one of Examples 11 to 12, further including dynamically determining whether to predict the predicted address or the predicted value based at least in part on a characteristic of an access for a value with one of the previously predicted addresses. Optionally, where the characteristic is selected from a group consisting of a length of time to complete the access for the value, whether there was a hit in a Level 1 (L1) cache during the access for the value, whether there was a hit in a cache hierarchy during the access for the value, and whether the access for the value stalled on a store.

Example 14 includes the method of any one of Examples 11 to 13, where the predicting is performed while a load operation corresponding to the load instruction is at allocation.

Example 15 includes the method of any one of Examples 11 to 14, where loading the value corresponding to the predicted address includes accessing the value from a cache hierarchy with the predicted address (e.g., after allocation of one or more decoded instructions corresponding to the load instruction and/or before an actual address has been generated based on address generation information associated with the load instruction), if the value corresponding to the predicted address is stored in the cache hierarchy and/or accessing the value from system memory with the predicted address if the value corresponding to the predicted address is not stored in the cache hierarchy.

Example 16 is a computer system or other system including a processor including a decode unit to decode a load instruction, the load instruction to indicate a destination register, a prediction unit to provide either a predicted address or a predicted value for the load instruction, and a memory execution unit coupled with the prediction unit. The memory execution unit is to load a value corresponding to the predicted address and store the loaded value in the destination register or store the predicted value in the destination register. The system also includes a dynamic random access memory (DRAM) coupled with the processor.

Example 17 includes the system of Example 16, where the prediction unit is to dynamically determine whether to provide the predicted address or the predicted value based at least in part on whether previously predicted addresses for previous instances of the load instruction were predicted correctly and whether previously predicted values for the previous instances of the load instruction were predicted correctly.

Example 18 includes the system of any one of Examples 16 to 17, where the prediction unit is to dynamically determine whether to provide the predicted address or the predicted value based at least in part on a characteristic of an access for a value with one of the previously predicted addresses.

Example 19 includes the system of Example 18, where the characteristic is selected from a group consisting of a length of time to complete the access for the value, whether there was a hit in a Level 1 (L1) cache during the access for the value, whether there was a hit in a cache hierarchy during the access for the value, and whether the access for the value stalled on a store.

Example 20 includes the system of any one of Examples 16 to 19, where the prediction unit is to provide either the predicted address or the predicted value when one or more decoded instructions decoded from the load instruction are at an allocation stage of a pipeline of the processor.

Example 21 is a processor or other apparatus operative to perform the method of any one of Examples 11 to 15.

Example 22 is a processor or other apparatus that includes means for performing the method of any one of Examples 11 to 15.

Example 23 is a processor or other apparatus that includes any combination of modules and/or units and/or logic and/or circuitry and/or means operative to perform the method of any one of Examples 11 to 15.

Example 24 is an optionally non-transitory and/or tangible machine-readable medium, which optionally stores or otherwise provides instructions including a first instruction, the first instruction if and/or when executed by a processor, computer system, electronic device, or other machine, is operative to cause the machine to perform the method of any one of Examples 11 to 15.

1. A processor comprising:
a decode unit to decode a load instruction, the load instruction to indicate a destination register;
a prediction unit to provide either a predicted address or a predicted value for the load instruction; and
a memory execution unit coupled with the prediction unit, the memory execution unit to:
load a value corresponding to the predicted address and store the loaded value in the destination register; or
store the predicted value in the destination register.

2. The processor of claim 1, wherein the prediction unit is to dynamically determine whether to provide the predicted address or the predicted value based at least in part on:
whether previously predicted addresses for previous instances of the load instruction were predicted correctly; and
whether previously predicted values for the previous instances of the load instruction were predicted correctly.

3. The processor of claim 2, wherein the prediction unit is to dynamically determine whether to provide the predicted address or the predicted value based at least in part on a characteristic of an access for a value with one of the previously predicted addresses.

4. The processor of claim 3, wherein the characteristic is selected from a group consisting of a length of time to complete the access for the value, whether there was a hit in a Level 1 (L1) cache during the access for the value, whether there was a hit in a cache hierarchy during the access for the value, and whether the access for the value stalled on a store.

5. The processor of claim 1, wherein the prediction unit comprises:
circuitry to maintain an address prediction confidence value that reflects whether previously predicted addresses for previous instances of the load instruction were predicted correctly; and
circuitry to maintain a value prediction confidence value that reflects whether previously predicted values for the previous instances of the load instruction were predicted correctly.

6. The processor of claim 1, wherein the prediction unit is to provide either the predicted address or the predicted value after allocation of one or more decoded instructions decoded from the load instruction.

7. The processor of claim 1, further comprising a cache hierarchy having a plurality of caches at a plurality of different levels, and wherein the memory execution unit, to load the value corresponding to the predicted address, is to:
access the value from the cache hierarchy with the predicted address after allocation of one or more decoded instructions corresponding to the load instruction and before an actual address has been generated based on address generation information associated with the load instruction, if the value corresponding to the predicted address is stored in the cache hierarchy; or
access the value from system memory with the predicted address if the value corresponding to the predicted address is not stored in the cache hierarchy.

8. The processor of claim 1, wherein the prediction unit is to identify the load instruction based on a combination of an instruction pointer for the load instruction and branch history information for the load instruction.

9. The processor of claim 1, wherein the prediction unit comprises a table having a plurality of entries, wherein a first entry of the plurality of entries is to be selected for the load instruction based on a combination of an instruction pointer for the load instruction and branch history information for the load instruction, wherein the first entry is to store either the predicted value for the load instruction if the predicted value is to be provided or one of the predicted address or an indication of the predicted address if the predicted address is to be provided.

10. The processor of claim 9, wherein a second entry of the plurality of entries is to be selected for a second load instruction based on a combination of an instruction pointer for the second load instruction and branch history information for the second load instruction, and wherein the second entry is to store a representation of a predicted address for the second load instruction, an address prediction confidence value corresponding to the representation of the predicted address, a representation of a predicted value for the second load instruction, and a value prediction confidence value corresponding to the representation of the predicted value.

11. A method comprising:
decoding a load instruction, the load instruction indicating a destination register;
predicting either a predicted address or a predicted value for the load instruction; and
loading a value corresponding to the predicted address and storing the loaded value in the destination register, in the case of predicting the predicted address; or
storing the predicted value in the destination register, in the case of predicting the predicted value.

12. The method of claim 11, further comprising dynamically determining whether to predict the predicted address or the predicted value based at least in part on:
whether previously predicted addresses for previous instances of the load instruction were predicted correctly; and
whether previously predicted values for the previous instances of the load instruction were predicted correctly.

13. The method of claim 12, further comprising dynamically determining whether to predict the predicted address or the predicted value based at least in part on a characteristic of an access for a value with one of the previously predicted addresses, and wherein the characteristic is selected from a group consisting of a length of time to complete the access for the value, whether there was a hit in a Level 1 (L1) cache during the access for the value, whether there was a hit in a cache hierarchy during the access for the value, and whether the access for the value stalled on a store.

14. The method of claim 11, wherein the predicting is performed while a load operation corresponding to the load instruction is at allocation.

15. The method of claim 11, wherein loading the value corresponding to the predicted address includes:
accessing the value from a cache hierarchy with the predicted address after allocation of one or more decoded instructions corresponding to the load instruction and before an actual address has been generated based on address generation information associated with the load instruction, if the value corresponding to the predicted address is stored in the cache hierarchy; or
accessing the value from system memory with the predicted address if the value corresponding to the predicted address is not stored in the cache hierarchy.

16. A system comprising:
a processor comprising:
a decode unit to decode a load instruction, the load instruction to indicate a destination register;
a prediction unit to provide either a predicted address or a predicted value for the load instruction; and
a memory execution unit coupled with the prediction unit, the memory execution unit to:
load a value corresponding to the predicted address and store the loaded value in the destination register; or
store the predicted value in the destination register; and
a dynamic random access memory (DRAM) coupled with the processor.

17. The system of claim 16, wherein the prediction unit is to dynamically determine whether to provide the predicted address or the predicted value based at least in part on:
whether previously predicted addresses for previous instances of the load instruction were predicted correctly; and
whether previously predicted values for the previous instances of the load instruction were predicted correctly.

18. The system of claim 16, wherein the prediction unit is to dynamically determine whether to provide the predicted address or the predicted value based at least in part on a characteristic of an access for a value with one of the previously predicted addresses.

19. The system of claim 18, wherein the characteristic is selected from a group consisting of a length of time to complete the access for the value, whether there was a hit in a Level 1 (L1) cache during the access for the value, whether there was a hit in a cache hierarchy during the access for the value, and whether the access for the value stalled on a store.

20. The system of claim 16, wherein the prediction unit is to provide either the predicted address or the predicted value when one or more decoded instructions decoded from the load instruction are at an allocation stage of a pipeline of the processor.
